(19) United States
(12) Patent Application Publication
(10) Pub. No.: US 2024/0057702 A1
(43) Pub. Date: Feb. 22, 2024

(54) Insulation Fill Material, and Related Articles, Systems and Methods

(71) Applicant: Allied Feather & Down Corp., Montebello, CA (US)

(72) Inventor: Reese Dwayne White, San Francisco, CA (US)

(21) Appl. No.: 18/034,705

(22) PCT Filed: Oct. 30, 2021
(86) PCT No.: PCT/US2021/057478

§ 371 Date: Apr. 30, 2023

Related U.S. Application Data
(60) Provisional application No. 63/108,038, filed on Oct. 30, 2020.

(51) Int. Cl. A41D 31/06; A47G 9/08

(52) U.S. Cl. CPC A41D 31/065; A47G 9/08

(57) ABSTRACT

Insulation fill materials, articles comprising these fill materials, and methods for manufacturing these fill materials, are disclosed. An insulation fill material may include a volume of base fill material and a multiplicity of platelets three-dimensionally dispersed throughout the base fill material. Alternatively or in addition, the insulation fill may include a sheet of base fill material having at least one outer surface, and a multiplicity of platelets applied to the at least one outer surface. The platelets may preferably have at least two flat-planar facets, and may comprise a metal core layer having a first face and a second face opposite thereof. The platelets may include a first film layer disposed on the first face and a second film layer disposed on the second face. Outer faces of the film layers may include polyethylene terephthalate. Articles such as apparel, sleeping bags, and bedding may comprise the insulation fill material.

### RELATED APPLICATIONS

This application claims the benefit of U.S. Provisional Application No. 63/108,038 filed Oct. 30, 2020, the contents which are incorporated by this reference in their entireties for all purposes as if fully set forth herein.

### TECHNICAL FIELD

The present disclosure relates generally to the field of insulation fill materials for use in articles such as apparel, sleeping bags, and bedding.

### BACKGROUND

Fibers of various origins have long been used to manufacture insulations for garments, gloves, sleeping bags, bedding. Each fiber has its own unique thermal performance attributes, and certain technologies have advanced to the point of treating these fibers to both increase performance and add additional benefits and increased durability beyond what would have been provided by the fibers themselves. By way of example, adding durable water-resistant chemistry to down has helped down-based insulation perform better when used in wet environments.

Among other problems addressed by the present disclosure, what is needed are improvements in insulative fill materials and related methods which increase the durable thermal efficiency of the articles employing these materials.

### SUMMARY

Certain deficiencies of the prior art may be overcome by the provision of one or more embodiments of insulation fill material, and associated articles and methods, in accordance with the present disclosure. The insulation fill material (which may otherwise be referred to herein by the trade name ThermaDown02+) may preferably comprise highly reflective mirror-like platelets as an additive/treatment to insulation used in outerwear, sleeping bags and bedding in order to increase thermal efficiency and add additional benefits of infrared energy through the reflection of energy expended by the body or environmental energy, back to the user within the full infrared spectrum.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic view of one example insulation fill material in accordance with the present disclosure;

FIG. 2 is a diagrammatic cross-sectional view of one example platelet in accordance with the present disclosure;

FIG. 3 is a diagrammatic cross-sectional view of a second example platelet in accordance with the present disclosure;

FIG. 4A is a diagrammatic perspective view of one example platelet in accordance with the present disclosure;

FIG. 4B is a diagrammatic perspective view of a second example platelet in accordance with the present disclosure;

FIG. 4C is a diagrammatic perspective view of a third example platelet in accordance with the present disclosure;

FIG. 4D is a diagrammatic perspective view of a fourth example platelet in accordance with the present disclosure;

FIG. 4E is a diagrammatic perspective view of a fifth example platelet in accordance with the present disclosure;

FIG. 4F is a diagrammatic perspective view of a sixth example platelet in accordance with the present disclosure;

FIG. 5A is a diagrammatic perspective view of a seventh example platelet in accordance with the present disclosure;

FIG. 5B is a diagrammatic perspective view of an eighth example platelet in accordance with the present disclosure;

FIG. 6A is a diagrammatic perspective view of one example article in accordance with the present disclosure, wherein the article is a jacket;

FIG. 6B is a diagrammatic perspective view of a second example article in accordance with the present disclosure, wherein the article is a sleeping bag;

FIG. 6C is a diagrammatic perspective view of a third example article in accordance with the present disclosure, wherein the article is a pillow;

FIG. 7 is a diagram illustrating infrared energy emitted from a human body proximate an article, and reflected back to the human body by way of insulation fill material in accordance with the present disclosure;

FIG. 8 is a diagrammatic flow chart illustrating one example method of manufacturing insulation fill material in accordance with the present disclosure;

FIG. 9 is a diagrammatic flow chart illustrating additional potential steps within the step of producing a multiplicity of platelets in accordance with the present disclosure;

FIG. 10 is a diagram illustrating one example system for manufacturing insulation fill material in accordance with the present disclosure;

FIG. 11 is a diagrammatic flow chart illustrating one alternate example method of manufacturing insulation fill material in accordance with the present disclosure;

FIG. 12 is a diagram illustrating one alternate example system for manufacturing insulation fill material in accordance with the present disclosure, wherein the resulting insulation fill material is in the form of a sheet;

FIG. 13A is a diagrammatic cross-sectional view of at least a portion of one alternate example article with insulation fill material in accordance with the present disclosure, wherein the insulation fill material is in the form of a sheet, and a multiplicity of platelets is applied to one outer surface of the precursor sheet of base fill material;

FIG. 13B is a diagrammatic cross-sectional view of at least a portion of an alternate example article similar to that of FIG. 13A, but wherein a multiplicity of platelets is applied to two outer surfaces of the precursor sheet of base fill material; and

FIG. 14 is a chart illustrating comparative reflective energy performance for fill materials using various additives.

### DETAILED DESCRIPTION OF THE PREFERRED EMBODIMENTS

Referring now to the drawings, like reference numerals designate identical or corresponding features throughout the several views.

Features of particular preferred embodiments of an insulation fill material, an article with insulation fill material, and a method of manufacturing an insulation fill material in accordance with the present disclosure are disclosed herein.

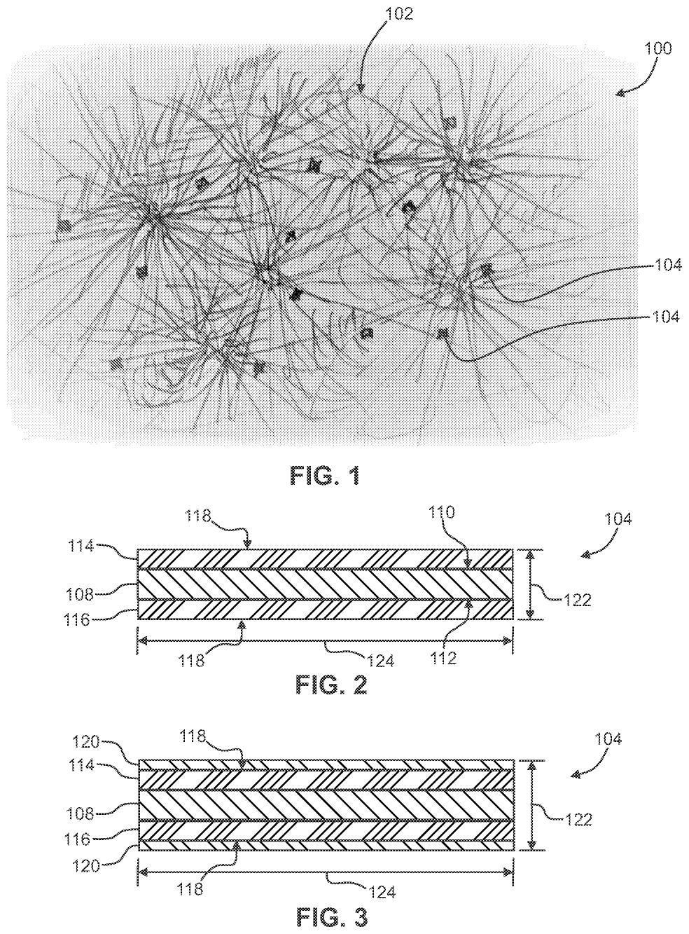

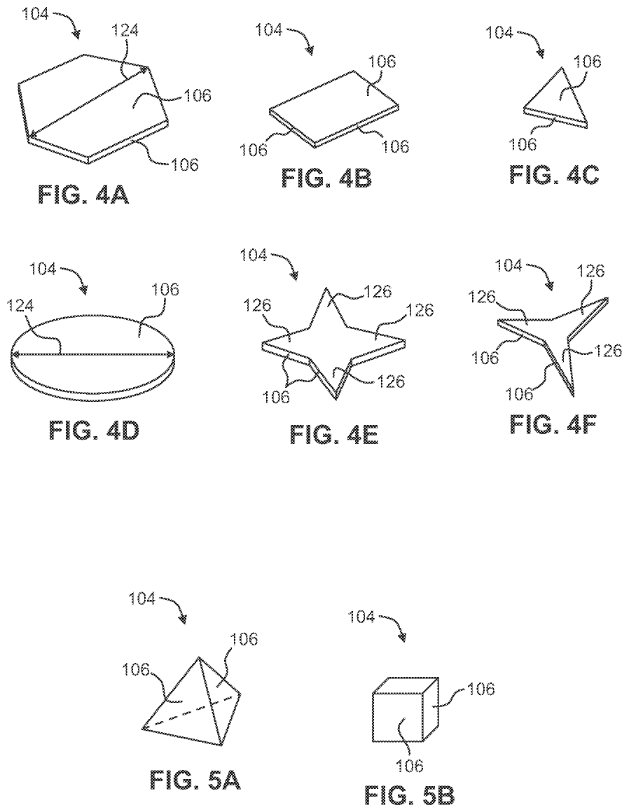

Certain example embodiments of an insulation fill material are shown generally at 100. Referring to FIG. 1, an insulation fill material 100 may comprise a volume of base fill material 102, and a multiplicity of platelets 104 three-dimensionally dispersed throughout the base fill material 102. Referring to FIGS. 4A-5B, each of the platelets 104 may have at least two flat-planar facets 106. Referring to FIGS. 2 and 3, the platelets 104 may preferably have a thickness 122 up to 0.35 mm and a width 124 of up to 5 mm. Alternatively, the platelets may each have a thickness of 0.03 mm to 0.35 mm, and a width of 0.1 mm to 5 mm or 0.1 mm to 3.8 mm.

Referring to FIGS. 2 and 3, the platelets 104 may each comprise a metal core layer 108. The metal core layer 108 may preferably be comprised of aluminum. The metal core layer may have a first face 110 and a second face 112 opposite of the first face. Moreover, the platelets may each comprise a first film layer 114 disposed on the first face 110 and a second film layer 116 disposed on the second face 112. The first film layer 114 and second film layer 116 may be comprised of a plastic material. The plastic material may preferably be polyvinyl chloride (PVC), thermoplastic polyurethane (TPU), thermoplastic elastomer (TPE), polyurethane (PU), or polyethylene terephthalate (PET). The first film layer 114 and the second film layer 116 may each include an outer face 118 disposed oppositely of the metal core layer 108. Referring to FIG. 3, the outer faces 118 may have a coating 120 disposed thereon. The coating may be polyurethane coating 120, and the first film layer 114 and second film layer 116 may be comprised of polyethylene terephthalate (PET). The platelets 104 may preferably have an infrared reflectivity of at least 85%, at least 90% or at least 95%.

In certain implementations of an insulation fill material 100, the platelets may have a specific gravity of 0.4-0.5. The term “specific gravity” may be conventionally understood as the relative density compared to water. In particular implementations of an insulation fill material 100, the platelets 104 may be hollow. The hollowness of a platelet 104 may be defined by an enclosed cavity within the platelet 104 that is filled with a gas, such as air.

In particular implementations of an insulation fill material 100, the base fill material may be a down, a synthetic, or a combination thereof.

In certain implementations of an insulation fill material 100, the platelets 104 may each have a greatest spatial dimension of 1 mm or less. In platelets 104 which are substantially planar in shape (e.g., as shown in FIGS. 4A-4F), the greatest spatial dimension would be synonymous with the width 124.

In particular implementations of an insulation fill material 100, the platelets 104 may each have two or more protruding members 126 radiating outwardly (see, e.g., FIGS. 4E and 4F).

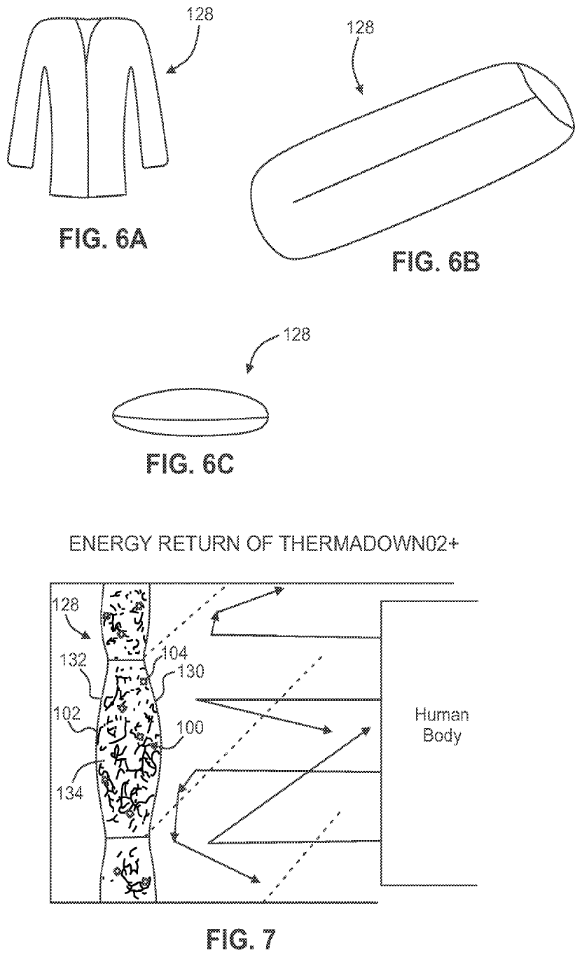

FIGS. 6A-6C illustrate example articles with insulation fill material 100. The articles may be, for example, an item of clothing or an item of bedding. For example, FIG. 6A illustrates a jacket, FIG. 6B illustrates a sleeping bag, and FIG. 6C illustrates a pillow. Referring to FIG. 7, an article 128 with insulation fill material 100 may comprise an inner textile layer 132, an outer textile layer 130 and a fill pocket 134 defined therebetween. The fill pocket 134 may envelope (e.g., contain) a quantity of insulation fill material 100 comprised of a precursor weight of base fill material 102 and a multiplicity of platelets 104 dispersed therein. each of said platelets having at least two flat-planar facets.

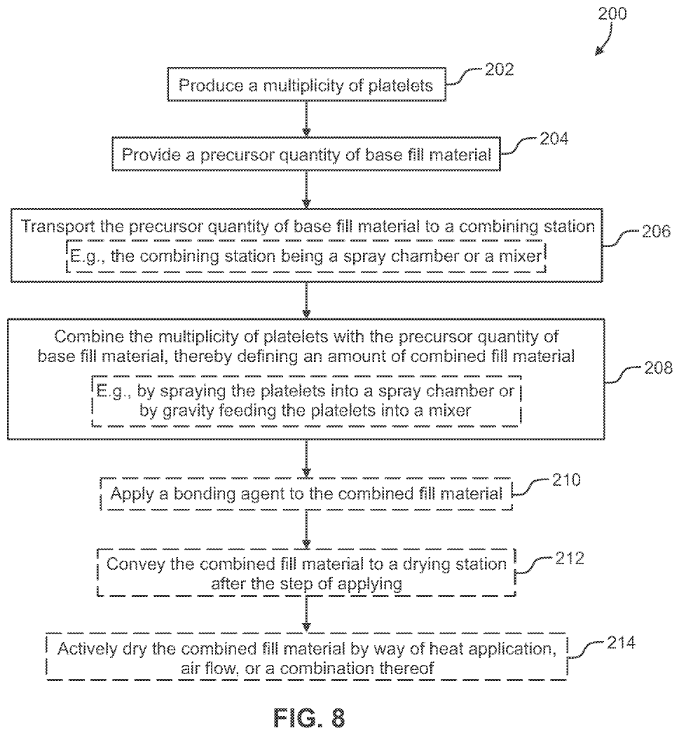

Referring to FIG. 8, one example method of manufacturing an insulation fill material 100 is shown at 200. Certain potential additional steps or details of this example method are illustrated in boxes with broken lines. At block 202, a multiplicity of platelets 104 is produced. At block 204, a precursor quantity 136 of base fill material 102 is provided. At block 206, the precursor quantity 136 of base fill material 102 is transported to a combining station 302. At block 208, the multiplicity of platelets 104 is combined with the precursor quantity of base fill material 102, thereby defining an amount of combined fill material.

In certain implementations of a method 200 of manufacturing an insulation fill material 100, the combining station may be a spray chamber, and the step of combining 208 includes spraying the platelets 104 into the spray chamber. In the alternative, the combining station may be a mixer, and the step of combining 208 may include gravity feeding the platelets 104 into the mixer.

Particular implementations of a method 200 of manufacturing an insulation fill material 100 may further comprise, as shown at block 210, applying a bonding agent to the combined fill material. At block 212, combined fill material may be conveyed to a drying station after the step of applying. At block 214, the combined fill material may be actively dried, for example, by way of heat application, air flow, or a combination thereof.

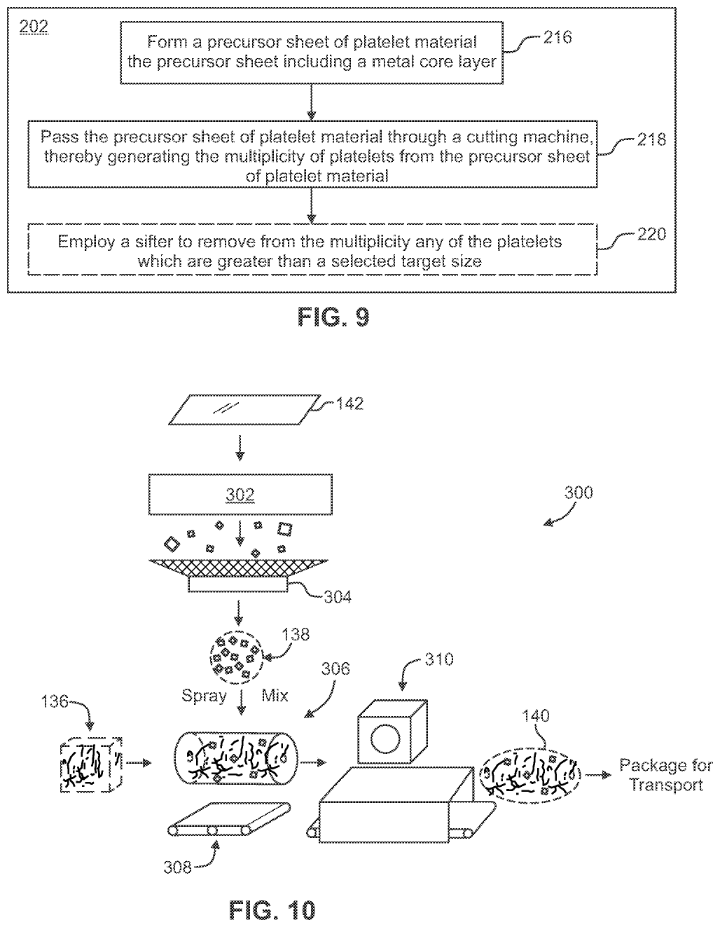

Referring to FIGS. 8, 9 and 10, in certain implementations of a method 200 of manufacturing an insulation fill material 100, the step of producing 202 may comprise several steps of its own. For example, at block 216, a precursor sheet 142 of platelet material may be formed. Referring to FIGS. 2, 3 and 10, the precursor sheet 142 may include a metal core layer 108 having a first face 110 and a second face 112 opposite of the first face 110. A first film layer 114 may be disposed on the first face 110 and a second film layer 116 may be disposed on the second face 112. Referring to FIGS. 9 and 10, step of producing 202 may comprise passing the precursor sheet 142 of platelet material through a cutting machine 302 (e.g., a high-speed rotary or laser die cutter), thereby generating the multiplicity 138 of platelets 104 from the precursor sheet 104 of platelet material. The step of producing 202 may further comprise, after the step of passing 218, employing a sifter 304 to remove from the multiplicity any of the platelets 104 which are greater than a selected target size.

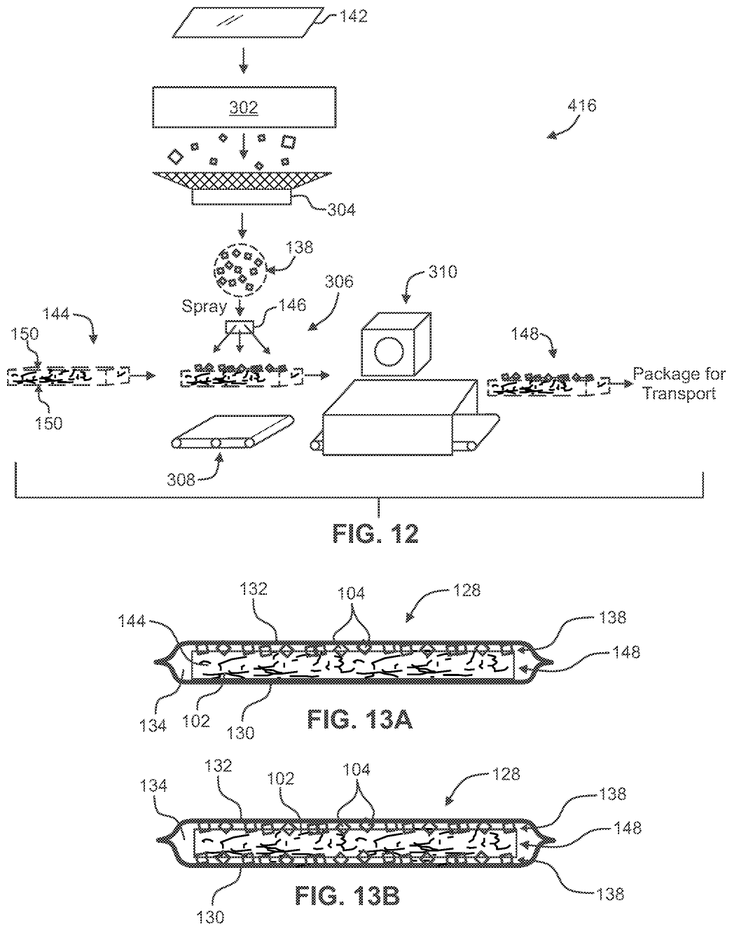

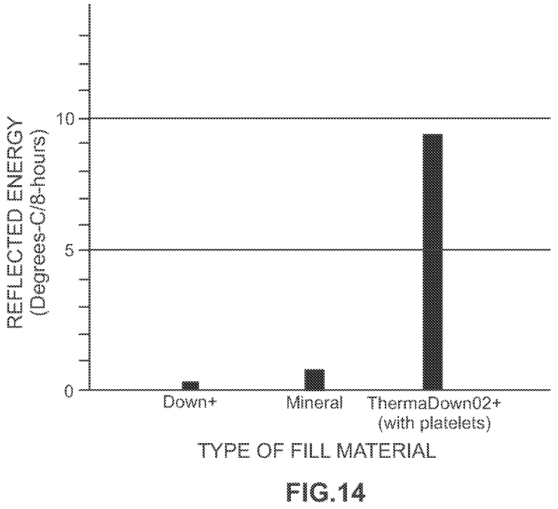

Certain alternate example embodiments of an insulation fill material are shown generally at 148. Referring to FIGS. 12, 13A and 13B, an insulation fill material 148 may comprise a sheet of base fill material 144. The sheet 144 may have at least one outer layer 150, and a multiplicity of platelets 104 applied to the at least on outer surface 150. Each of the platelets 104 may be constructed and manufactured as described elsewhere herein.

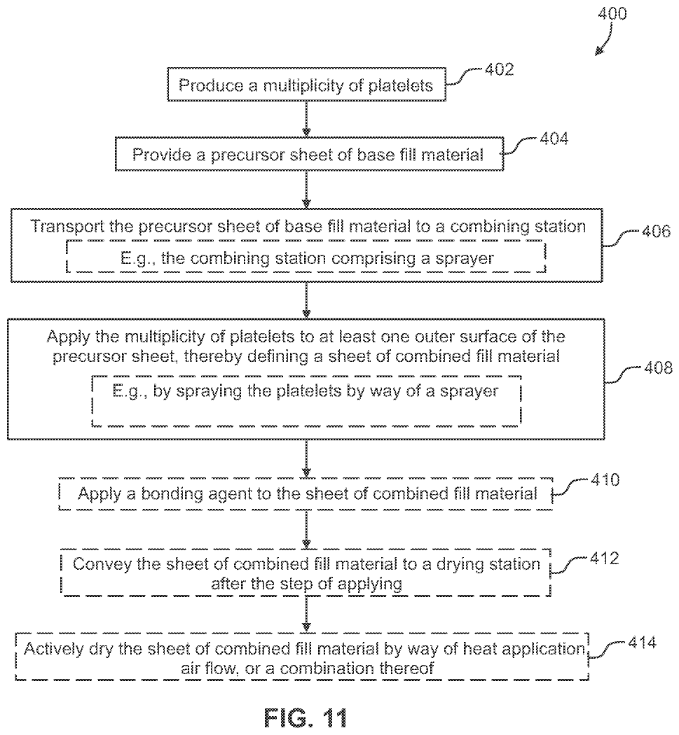

Referring to FIG. 11, one alternate example method of manufacturing an insulation fill material 148 is shown at 400. Certain potential additional steps or details of this example method are illustrated in boxes with broken lines.

In certain implementations of a method 200 of manufacturing an insulation fill material 100, the combining station may be a spray chamber, and the step of combining 208 includes spraying the platelets 104 into the spray chamber. In the alternative, the combining station may be a mixer, and the step of combining 208 may include gravity feeding the platelets 104 into the mixer.

FIG. 12 is a diagram illustrating one alternate example system 416 for manufacturing insulation fill material 148, wherein the resulting insulation fill material 148 is in the form of a sheet. Relatedly, FIG. 13A illustrates at least a portion of an example article 128 with insulation fill material 148 wherein a multiplicity of platelets 104 has been applied to one outer surface 150 of the precursor sheet of base fill material 144. Contrastingly, FIG. 13B illustrates at least a portion of an alternate example article 128 similar to that of FIG. 13A, but wherein a multiplicity of platelets 104 is applied to two outer surfaces 150 of the precursor sheet of base fill material 144.

The following listing matches certain terminology used within this disclosure with corresponding reference numbers used in the non-limiting examples illustrated in the several figures.
100 insulation fill material (e.g., combined fill material)
102 base fill material (e.g., down, polyfill, batting, synthetic or other loose, woven, or other non-woven or loose, 3D material)
104 platelet
106 facet (e.g., flat-planar)
108 metal core layer (e.g., aluminum)
110 first face (of metal core layer)
112 second face (of metal core layer)
114 first film layer (e.g., plastic material such as PVC, TPU, TPE, PU or PET)
116 second film layer (e.g., plastic material such as PVC, TPU, TPE, PU or PET)
118 outer face (of film layer)
120 coating (e.g., polyurethane)
122 platelet thickness
124 platelet width (i.e., greatest width)
126 protruding member (of platelet; e.g., sharp and/or pointed)
128 article with insulation fill material (e.g., wearable items or bedding)
130 inner textile layer (of article)
132 outer textile layer (of article)
134 fill pocket (of article)
136 precursor quantity of base fill material (e.g., by precursor weight or precursor volume)
138 multiplicity of platelets (e.g., measurable by weight or volume)
140 quantity of insulation fill material (e.g., measurable by weight or volume)
142 precursor sheet of platelet material
144 precursor sheet of base fill material (e.g., provided from a roll of batt base fill material)
146 sprayer
148 sheet of insulation fill material (e.g., combined fill material)
150 outer surface (of sheet of base fill material)
200 example method of manufacturing an insulation fill material
202-214 steps of method 200
300 system for manufacturing insulation fill material
302 cutting machine (e.g., rotary cutter or die cutter)
304 sifter (to remove excessively large or uncut pieces of platelet material)
306 combining station (e.g., spray chamber or mixer)
308 bonding agent application station
310 drying station
400 alternate example method of manufacturing an insulation fill material
402-414 steps of method 400
416 system for manufacturing sheet insulation fill material

In certain implementations of an insulation fill material 100, the term “platelet” may be defined as a material that consists of anywhere from two to infinite flat facets. However, in certain cases, a platelet may comprise a rounded, spherical or spheroidal shape. The surfaces that form facets may be cut or otherwise machined to shape.

The present disclosure involves a new technology for the coating, application and/or treatment of existing insulations and insulating fibers with highly reflective platelets in order to increase insulating benefits based on the insulation's ability to directionally reflect discharged energy back to the user within a full infrared spectrum.

ThermaDownO2+ treatment may use infrared reflectivity to both increase thermal efficiency (greater warmth) while adding benefits of infrared energy reflectivity including increased microcirculation resulting in better thermoregulation and increased oxygen carried to the muscles for faster recovery and increased performance where technical insulations are needed. The benefits of this infrared reflectivity can also lead to a better sleep for bedding products utilizing this technology.

Conventional insulating fibers typically work by either keeping the cold out or the warmth in, and are generally passive. As a result, there can be a tremendous amount of energy from the surrounding environment lost or not utilized that could otherwise have significant impact on thermal efficiency and aid in increasing benefits found through the return of energy within an infrared spectrum.

Infrared energy has been used by many cultures and has gained adoption globally for its proven ability to increase microcirculation. In textiles, infrared minerals have been topically applied and incorporated into textiles that return reflected energy within a narrow infrared spectrum.

There are at least two distinct advantages of increasing microcirculation through infrared reflectivity. One is the increase in thermal efficiency (greater warmth). The second in aiding in the user's performance and recovery by carrying more oxygen to the muscles through the process of vasodilation.

The current technology for infrared reflectivity generally relies upon a relatively small number of ceramic minerals. These minerals have shown to be highly inefficient in reflectivity and are believed to be reflective within a very narrow spectrum.

The new solutions described and claimed herein differ in part by incorporating highly reflective micro-platelets onto or into the insulating fibers to increase reflective efficiency within a full infrared spectrum. Increasing efficiency and opening the spectrum beyond current technologies helps provide much larger benefit for a wider range of users.

Insulation works based on the three primary heat (energy) transfer mechanisms—conduction, convection and radiation. Conduction is the way heat (energy) is transferred directly from one material to the next. Convection is heat or energy circulating through liquid or gases. Radiant heat (energy) travels in a straight line and heats anything solid in its path.

This delivery of heat from the hot surface is done via infrared radiation. Heat from the sun, for example, is the most common type of radiant heat we experience.

Most insulation works generally by either slowing the conductive heat flow or decreasing the convection heat flow—or to some degree, a level of both. Reflective insulations are generally a very thin sheet of reflective material or foil that simply work only with or against radiant heat.

The conventional art appears to lack insulations that effectively work with all three heat transfer mechanisms in order to maximize efficiency and performance. By incorporating micro sized reflective platelets into the more common convective and conductive insulation fibers, the insulation can perform significantly better and with much greater efficiency.

By using highly reflective platelets and incorporating onto (and not imbedded deep within) the surface of the fibers and materials used for conductive and convection based insulations, reflectivity of radiated infrared energy is highly increased, due to the reflective nature of the platelets allowing for a more intense reflection. The materials used to create such platelets may also have the ability to reflect within the full IR spectrum.

IR reflective treatments/additives based on minerals have the benefit of being ground very fine making them easy to embed and apply. However, they are believed to be almost six times less reflective, and their reflectivity is bound to a very small band within the IR spectrum.

Using micro reflective platelets ON insulating fibers preserves the conductive/convective insulation properties of the fibers while amplifying IR reflectivity within a full IR spectrum. In a garment, for example, a platelet treated down insulation can have the thermal efficiency of down with an energy return similar to reflective blankets used to increase microcirculation in diabetic patients or the space blankets used in extreme situations to reduce heat loss from a person's body.

The reflectivity of the platelets when applied to a three-dimensional fiber provide a highly reflective energy over a wide yet defined space—much like how a faceted disco ball works. Conventionally, most reflective minerals used in fibers appear to resemble imperfect “clumps” that only have the capacity to reflect a small portion of the energy directed at them.

The term “fibers” as used herein may refer to any three dimensional component of an insulation. These fibers can come together and be filled as a lose insulation or batted into sheets. Examples of fibers may include but not be limited to down and feather, polyester, recycled cotton, wool, milkweed, bio-based fibers (PLA, Lyocel, as an example), etc. Platelets may be applied to these fibers of any size or origin. Those fibers then become the base for the insulation for garment, sleeping bag, filled bedding product, etc.

Tests have shown that varied load (application) percentages will produce results in a parabolic curve where reflectivity starts to level off at a certain load amount. Different fibers will have slightly different curves, but generally, loading a combination of reflective platelets at between 90-100% of treatment and ceramic minerals (10-0% of treatment) at a load percentage between 1% and 20% of the weight of the fibers has shown to provide increased insulation and potential performance benefits for garments, sleeping bags and filled bedding products.

Application can be done through a variety of methods depending upon the material to be treated. Spray and bath have both shown to be effective for a wide range of insulating fibers including down. Inclusion of a binding agent allows for durability. Binding agents will also vary depending upon fibers to be treated. Binding materials provide durability allowing the platelets to remain on the fiber through use and washing. Binding agents should not react negatively with the particular fiber being used.

Depending on the type of base insulation material to be coated, the desired load will vary. Each material is tested with a variety of load ratios to ensure increased performance/efficiency while not reducing the conductive/convective insulating performance of the base fiber. Even within a single type of base insulation material such as down and feather, different qualities of the raw material may require a different load amount by weight.

### Application of Reflective Platelets to Down to Increase Insulation Benefits

For down, loading between 1% and 15% shows optimal performance, but should not be limited to those percentages.

Loading may be done either during the regular processing by including the platelets in a rinse bath or completely following washing by use of a spray method.

Prior to processing, the platelets can be measured at the desired weight in relation to the down to be processed. Final determination of % by weight may preferably be based on the quality of the material, final cost and desired effect.

If done by bath, platelets are added together with binding agent to one of the rinses following the initial washing of the down material. The material is then dried where the heat of the drier cures the binding agent.

For sprayer application, the above quantity of platelet material may be air blown into a large spray chamber along with a liquid binder while fibers are being agitated, as is used in other chemical treatments to down. The material may then be left to agitate for initial curing before being moved into a drier for complete curing. Duration and heat of curing is dependent upon fiber material and binding agent.

### Application of Additional Ceramic Minerals to Down to Provide Authentication, Traceability and/or Verification of Infrared Insulation Benefits

For down and other fibers that benefit from high-level traceability and authentication, the inclusion of additional reflective ceramic minerals can add authentication capability without reducing the increased insulation benefits of the infrared platelets.

The supply chain for many natural fibers is extremely complex, and traceability has become increasingly important. Standards have been created to help certify said material, but almost all current standards rely on a transaction certificate network with a potentially large margin of error. By incorporating a pre-defined combination of reflective ceramic minerals, an infrared reader can read the light “signature” reflected off of these minerals through the fabrics at completion of production to ensure authenticity. Each combination of reflective minerals will provide reflectivity within an extremely narrow spectrum (signature) able to be identified by the reader.

For certain implementations of this invention, it may also be important to be able to verify that no other material has been added to the complete insulation which could significantly decrease performance regardless of the type of fibers treated. Inclusion of additional infrared reflective minerals can help verify to a high degree whether foreign materials have been added throughout production ensuring claimed performance and authenticating fibers and brands utilizing such invention.

There are a number of different reflective minerals which can be combined in a number of ways to create unique “signature” reflections. Blending in 1-4% of the 3-10% of weight of the total treatment of the added reflective minerals allow these signatures to be read with simple readers.

Loading may be done exactly the same way as above and included with the platelets. In preferred implementations, the additional ceramic minerals do not affect the processing method.

### Application of Reflective Platelets to Alternative Fibers

Application of infrared platelets can also be topically loaded on to alternative fibers such as virgin and recycled polyester fibers and microfibers, wool, cotton, milkweed, Kapok, PLA, Fiberglass and others.

Synthetic fiber insulation usually consists of two forms, blowable and batted.

Loading on blowable fiber insulation can be sprayed in the same way it is applied to down as mentioned above. Loading weight range increases on synthetic fibers due to their less lofty nature and will be, for example, 3-20% by weight of fibers.

For batted insulation (otherwise known as batt insulation), the infrared platelet treatment can be topically applied after material is manufactured into a batted sheet. Application load for batted alternative fibers may remain 3-20%. Batted insulation may be made from any width (typically 45″, 60″, 90″, etc.), any length (usually a continuous roll); and nearly any thickness (For example, 3 mm-200 mm, or 0.125″-8″).

### Examples of Use

For garments, the ability of infrared energy to work directly with the vascular system creates the potential for increased microcirculation in addition to the non-treated insulating abilities. Benefits of infrared treated insulation include increased warmth, aided recovery, the ability to perform better for longer period of time and thermoregulation.

This benefit lends itself to use in all clothing, outdoor equipment, and insulated textiles such as:
Sleeping bags
High altitude parkas, pants and suits
Jackets and vests
Insulated Mid-layers
Insulated hats, gloves, mitts and scarves
booties and slippers
insulated socks
Bedding
Insulated Mid-Layers
High Altitude Equipment
Any insulated fabrics/textiles used in the creation of the above

Preferred embodiments of the platelets 104 described herein, and the insulation fill material and articles incorporating such platelets, are adapted to reflect FSIR (full spectrum infra-red light) back to the warm-blooded user with a number of benefits. The platelets may be made of any highly reflective material, of any size. Optimum size and weight will not hinder the other qualities of the applied to medium. The platelets may be dry applied, scattered throughout, dry applied and wet bonded, wet applied with or without binding agents either via gravity, forced air or forced air+liquid, slurry or any other transfer medium to 3-dimensional insulation, down, batting or other loose, woven, or other non-woven or loose, 3-dimensional material. This differs from any fabric coated reflective material, at least in that it is randomly placed throughout a 3-dimensional space, usually insulation, reflecting FSIR back to the user. This also differs from any conventional spray coating, or spray application in that the platelets are applied as a solid, although other transfer assist and/or bonding medium may be solid, liquid, aerosol or gaseous.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. An insulation fill material comprising:
a volume of base fill material; and
a multiplicity of platelets three-dimensionally dispersed throughout the base fill material, each of said platelets having at least two flat-planar facets;
wherein the platelets have a thickness up to 0.35 mm and a width of up to 5 mm.

2. An insulation fill material as defined in claim 1, wherein the platelets each comprise a metal core layer having a first face and a second face opposite of the first face.

3. An insulation fill material as defined in claim 2, wherein the platelets each comprise a first film layer disposed on the first face and a second film layer disposed on the second face.

4. (canceled)

5. An insulation fill material as defined in claim 3, wherein the first and second film layers are comprised of polyethylene terephthalate (PET).

6-8. (canceled)

9. An insulation fill material as defined in claim 2, wherein the base fill material is a down or synthetic.

10-12. (canceled)

13. An insulation fill material as defined in claim 2, wherein the platelets each have two or more protruding members radiating outwardly.

14-16. (canceled)

17. An article with insulation fill material, the article comprising:
an inner textile layer, an outer textile layer and a fill pocket defined therebetween, the fill pocket enveloping a quantity of insulation fill material comprised of a precursor weight of base fill material and a multiplicity of platelets dispersed therein, each of said platelets having at least two flat-planar facets.

18. An article as defined in claim 17, wherein the platelets each comprise a metal core layer having a first face and a second face opposite of the first face.

19. An article as defined in claim 18, wherein the platelets each comprise a first film layer disposed on the first face and a second film layer disposed on the second face.

20. (canceled)

21. An article as defined in claim 19, wherein the first and second film layers are comprised of polyethylene terephthalate (PET).

22. (canceled)

23. An article as defined in claim 18, wherein the metal core layer is comprised of aluminum.

24. (canceled)

25. An article as defined in claim 18, wherein the base fill material is a down or synthetic.

26-28. (canceled)

29. An article as defined in claim 18, wherein the platelets each have two or more protruding members radiating outwardly.

30-32. (canceled)

33. An article as defined in claim 17, wherein the article is an item of clothing or an item of bedding.

34. A method of manufacturing an insulation fill material, the method comprising:
producing a multiplicity of platelets, each of said platelets having at least two flat-planar facets;
providing a precursor quantity of base fill material;
transporting said precursor quantity of base fill material to a combining station; and
combining the multiplicity of platelets with the precursor quantity of base fill material, thereby defining an amount of combined fill material.

35. A method as defined in claim 34, wherein
the combining station is a spray chamber; and
the step of combining includes spraying the platelets into the spray chamber.

36. (canceled)

37. A method as defined in claim 34, further comprising:
applying a bonding agent to the combined fill material.

38. A method as defined in claim 37, further comprising
conveying the combined fill material to a drying station after the step of applying the bonding agent; and
actively drying the combined fill material by way of heat application, air flow, or a combination thereof.

39. A method as defined in claim 34, wherein the step of producing comprises:
forming a precursor sheet of platelet material, the precursor sheet including
a metal core layer having a first face and a second face opposite of the first face; and
a first film layer disposed on the first face and a second film layer disposed on the second face; and
passing the precursor sheet of platelet material through a cutting machine, thereby generating the multiplicity of platelets from the precursor sheet of platelet material.

40-41. (canceled)

42. A method as defined in claim 39, wherein the first and second film layers are comprised of polyethylene terephthalate (PET).

43. (canceled)

44. A method as defined in claim 39, wherein the metal core layer is comprised of aluminum.

45. (canceled)

46. A method as defined in claim 39, wherein the platelets each have two or more protruding members radiating outwardly.

47. An insulation fill material comprising:
a sheet of base fill material, the sheet having at least one outer surface; and
a multiplicity of platelets applied onto the at least one outer surface, each of said platelets having at least two flat-planar facets;
wherein the platelets have a thickness up to 0.35 mm and a width of up to 5 mm.

48. An insulation fill material as defined in claim 47, wherein the platelets each comprise a metal core layer having a first face and a second face opposite of the first face.

49. An insulation fill material as defined in claim 48, wherein the platelets each comprise a first film layer disposed on the first face and a second film layer disposed on the second face.

50. (canceled)

51. An insulation fill material as defined in claim 49, wherein the first and second film layers are comprised of polyethylene terephthalate (PET).

52. (canceled)

53. An insulation fill material as defined in claim 48, wherein the metal core layer is comprised of aluminum.

54. (canceled)

55. An insulation fill material as defined in claim 48, wherein the base fill material is a down or synthetic.

56-58. (canceled)

59. An insulation fill material as defined in claim 47, wherein the platelets each have two or more protruding members radiating outwardly.

60-62. (canceled)

63. An article with insulation fill material, the article comprising:
an inner textile layer, an outer textile layer and a fill pocket defined therebetween, the fill pocket enveloping a sheet of insulation fill material comprised of a precursor sheet of base fill material and a multiplicity of platelets applied to at least one outer surface of the precursor sheet, each of said platelets having at least two flat-planar facets.

64. An article as defined in claim 63, wherein the platelets each comprise a metal core layer having a first face and a second face opposite of the first face.

65. An article as defined in claim 64, wherein the platelets each comprise a first film layer disposed on the first face and a second film layer disposed on the second face.

66. (canceled)

67. An article as defined in claim 65, wherein the first and second film layers are comprised of polyethylene terephthalate (PET).

68. (canceled)

69. An article as defined in claim 64, wherein the metal core layer is comprised of aluminum.

70. (canceled)

71. An article as defined in claim 64, wherein the base fill material is a down or synthetic.

72-74. (canceled)

75. An article as defined in claim 64, wherein the platelets each have two or more protruding members radiating outwardly.

76. An article as defined in claim 64, wherein the platelets each have a thickness of 0.03 mm to 0.35 mm and a width of 0.1 mm to 5 mm.

77-78. (canceled)

79. An article as defined in claim 63, wherein the article is an item of clothing or an item of bedding.

80. A method of manufacturing an insulation fill material, the method comprising:
producing a multiplicity of platelets, each of said platelets having at least two flat-planar facets;
providing a precursor sheet of base fill material, the precursor sheet having at least one outer surface;
transporting said precursor sheet of base fill material to a combining station;
applying the multiplicity of platelets to the at least one outer surface, thereby defining a sheet of combined fill material.

81. A method as defined in claim 80, wherein
the combining station comprises a sprayer; and
the step of applying the multiplicity of platelets includes spraying the platelets by way of the sprayer.

82. A method as defined in claim 80, further comprising:
applying a bonding agent to the sheet of combined fill material.

83. A method as defined in claim 82, further comprising
conveying the sheet of combined fill material to a drying station after the step of applying the bonding agent; and
actively drying the sheet of combined fill material by way of heat application, air flow, or a combination thereof.

84. A method as defined in claim 80, wherein the step of producing comprises:
forming a precursor sheet of platelet material, the precursor sheet including
a metal core layer having a first face and a second face opposite of the first face; and
a first film layer disposed on the first face and a second film layer disposed on the second face; and
passing the precursor sheet of platelet material through a cutting machine, thereby generating the multiplicity of platelets from the precursor sheet of platelet material.

85-86. (canceled)

87. A method as defined in claim 84, wherein the first and second film layers are comprised of polyethylene terephthalate (PET).

88. (canceled)

89. A method as defined in claim 84, wherein the metal core layer is comprised of aluminum.

90. A method as defined in claim 84, wherein the platelets have a specific gravity of 0.4-0.5.

91. (canceled)
